(19) United States
(12) Patent Application Publication
(10) Pub. No.: US 2004/0073549 A1
(43) Pub. Date: Apr. 15, 2004

(54) Query resolution system

(76) Inventors: Itzhak Turkel, Ramat-Hasharon (IL); Reuven Moskovich, Tel-Aviv (IL); Eliezer Levy, Haifa (IL); Eliav Menachi, Ashdod (IL); Ziv Keir, Tel-Aviv (IL); Ran Giladi, Omer (IL); Shahar Gang, Kiryat-Ono (IL); Yehuda Weinraub, Beer Sheva (IL); Michael Shurman, Bat-Hefer (IL)

Correspondence Address: William H Dippert, Reed Smith, 29th Floor, 599 Lexington Avenue, New York, NY, 10022-7650, US

(21) Appl. No.: 10/468,707

(22) PCT Filed: Feb. 21, 2002
(86) PCT No.: PCT/IL02/00136

(30) Foreign Application Priority Data
Feb. 22, 2001 (IL) 141599

(51) Int. Cl. G06F 17/30

(52) U.S. Cl. 707/5

(57) ABSTRACT

A method of resolving a plurality of database queries. The method includes accumulating a plurality of queries, determining overlapping portions of the queries that relate to one or more common data attributes, resolving at least two of the determined overlapping portions of the queries together, and preparing responses to the queries based on the resolution of the at least two overlapping portions.

### FIELD OF THE INVENTION

The present invention relates to data storage access systems.

### BACKGROUND OF THE INVENTION

Storage access systems store large amounts of data, and provide specific data segments to users in response to user requests. Storage access systems include, for example, Internet site servers and inquiry-response database systems.

Conventional storage access systems comprise a general purpose computer which has a user interface (e.g., a monitor or a network interface) for receiving user requests and one or more storage devices which store the data. These conventional storage access systems are limited in the amount of requests they can serve in a given period, by the processing power of the processor and the throughput of the storage devices. Increasing the number of requests serviced in a given period beyond the above limit requires adding an additional storage access system and a load balancer which distributes the requests between the storage access systems.

U.S. Pat. No. 5,230,073 of Gausmann et al., the disclosure of which is incorporated herein by reference, describes a storage access system for query databases. The storage access system includes a storage pump associated with storage devices which store a database. The storage pump continuously transmits the database on a high bandwidth distribution medium, such that the entire database is transmitted repeatedly every T seconds. A plurality of record retrieval elements receive user queries and determine records of the database which fulfill the user queries. The storage access system may transmit some of the records a multiple number of times within an interval T.

The system of the U.S. Pat. No. 5,230,073 is limited in its response time, as answering a query may take up to T seconds, depending on the time at which a query is received relative to the database transmission cycle. For very large databases, this disadvantage is enhanced.

Many web-sites provide dynamic web-pages which generally provide different data to different users according to the contents of a client request. For example, search engines provide users with the results of a search based on search attributes provided by the user. When a dynamic web-page is requested, the web server consults an application server which prepares the requested page. In some cases, the application server consults a database server, for example a database of the contents of web sites. The Database is usually stored on one or more disks with which the database server is associated. Alternatively to save on access time the database or parts thereof are stored in a very large random access memory (RAM). The web server generally resolves the query by checking the query on each of the entries of the database. In some cases, the order in which the query is checked on the entries of the query is planned to reduce the access time to the memory or disk storing the database.

In order to enhance the number of requests which are handled by a web server it is required, in some cases to enhance the operation of the database server. One method of enhancing the number of requests handled by a database server includes generating a plurality of copies of the database and splitting the queries between the databases.

Above-mentioned U.S. Pat. No. 5,230,073 describes a storage access system which serves as a database server. A record storage pump transmits a database on a high bandwidth distribution medium to which a plurality of record retrieval elements. Each record retrieval element resolves a number of queries during each database transmission interval, according to the transmission rate.

### SUMMARY OF THE INVENTION

An aspect of some embodiments of the present invention relates to a database server which accumulates batches of queries and resolves the queries together, optionally with fewer passes over the data referred to by the queries than required if each of the queries in the batch were resolved separately. Optionally, the database server resolves the batch of queries with the same number of passes over the data as required to resolve a single query in the batch. In some embodiments of the invention, the batch of queries are resolved with a single pass over the referred data.

In some embodiments of the invention, the database server passes over a data table referred to by the batch of queries and for each entry in the table checks whether it fulfills each of the queries in the batch, before checking the next entry in the table. In some embodiments of the invention, resolving the batch of queries together is performed using a content associated memory (CAM) in which the queries are stored. In other embodiments of the invention, the batch of queries are organized in a hash structure and the queries are resolved together by looking up each of the table entries in the hash structure. In still other embodiments of the invention, resolving a batch of queries together is performed using a plurality of resolution units which receive portions of the database concurrently from a common bus. Optionally, in these embodiments, the handling of each table entry for all the queries is performed in a single processor cycle of the database server.

In some embodiments of the invention, the batches of queries which are resolved together comprise queries relating to one or more common attributes (i.e., table columns). Alternatively or additionally, the batches of queries which are resolved together comprise queries including the same conditions (e.g., inequality, equality, greater than).

In some embodiments of the invention, the batches of queries resolved together comprise query fragments. Optionally, the database server parses at least some of the database queries it receives into fragments and collects similar fragments into batches which are resolved together. After resolving all the query fragments forming the parsed database queries, the database server determines the results of the parsed queries based on the results of the resolved query fragments.

In some embodiments of the invention, the database queries are parsed into single condition queries, i.e., queries which include only a single condition. Alternatively or additionally, the database queries are parsed into single attribute queries, i.e., queries which relate only to a single attribute.

An aspect of some embodiments of the invention relates to a database server which includes a plurality of execution units which differ in the methods they use to resolve same queries. Optionally, the execution units receive queries of specific structures and resolve the queries using specific methods. Optionally, the execution units are adapted to resolve single condition queries and/or single attribute queries. In some embodiments of the invention, the database server additionally comprises one or more units that are adapted to resolve queries using a plurality of different methods.

An aspect of some embodiments of the invention relates to a database server which includes a plurality of execution units, at least some of the execution units differ in at least one of processing power, memory size, internal structure and resolution methods. In some embodiments of the invention, the database server comprises a plurality of processors having different processing power and/or running different software. Alternatively or additionally, one or more of the execution units comprise dedicated hardware units directed to perform specific respective tasks. When a query is received, an execution unit to handle the query is selected, optionally responsive to the type of the query or to one or more parameters to which the query relates.

An aspect of some embodiments of the invention relates to a database server accelerator, which has a plurality of memory units associated with separate execution machines. In some embodiments of the invention, at least some queries handled by the accelerator are resolved jointly by a plurality of the execution machines. The memory units optionally cache different portions of the accelerated database. A scheduler (referred to also as a resource governor or resource manager) optionally determines which portions of the database are cached in each memory unit and/or which queries are performed by each execution machine. Use of a plurality of execution machines that have separate memory units, allows the accelerator to have an amount of memory larger than the address space that can be accessed by a single execution machine.

In some embodiments of the invention, a single resource governor controls the contents of a plurality of the memory units, so as to maximize the acceleration affect of the accelerator. In some embodiments of the invention, the resource governor controls the contents of the memory units in a manner which prevents a plurality of memory units from caching the same database portions. Alternatively or additionally, the resource governor instructs a plurality of the memory units to store a single database portion in a plurality of the memory units for better parallel resolution of one or more frequent database queries.

In some embodiments of the invention, a single compiler is used to convert database queries received by the accelerator into code segments executable by the execution machines, for a plurality of the execution machines.

Optionally, the database accelerator resolves at least some queries in a plurality of different execution machines associated with different memory units.

In some embodiments of the invention, at least one of the execution machines includes a plurality of processors, which operate in parallel using parallel database processing methods known in the art. Optionally, each of the processors of a machine can address all the address space of the machine. Alternatively or additionally, at least some of the portions of the memory of the machine are assigned for use by fewer than all the processors of the machine.

An aspect of some embodiments of the present invention relates to determining which database commands should be handled by an accelerator, at least partially according to quality of service (QoS) ratings of the commands. Optionally, commands having a high quality of service are given priority in determining which commands are handled by the accelerator. Alternatively, high QoS commands are given priority in being handled by a primary database server accelerated by the accelerator. In some embodiments of the invention, a resource governor determines which data portions are to be cached by the accelerator according to the queries recently received by an accelerated database server. Optionally, data portions referenced by high QoS queries receive precedence in the determination of which data portions are to be cached. Queries are optionally considered to have a high QoS when they are marked as such by a client generating the queries. Alternatively or additionally, a QoS rating is assigned to the queries according to the client from which the query was received.

An aspect of some embodiments of the invention relates to a database server adapted to provide faster responses to queries designated as having a high quality of service (QoS). In an exemplary embodiment of the invention, the database server generally accumulates a plurality of queries that are resolved together. High QoS queries, however, are optionally passed for immediate resolution, without waiting until a batch of queries is resolved.

An aspect of some embodiments of the invention relates to a database server accelerator which enhances a database server. Optionally, the accelerator accepts for handling only some database requests and transfers other database requests to the database server being accelerated. In some embodiments of the invention, the database server accelerator only resolves queries and does not perform data updates. Alternatively or additionally, the accelerator only resolves queries related to specific portions of the database. Further alternatively or additionally, the database server accelerator only resolves queries of a certain format, for example simple queries. In some embodiments of the invention, the accelerator does not resolve queries which do not conform to time constraints of a pipeline scheme of the accelerator.

An aspect of some embodiments of the present invention relates to a storage access system that includes a plurality of execution blocks which resolve database queries. A database memory selectively sweeps portions of the database to the execution blocks, responsive to the queries currently being handled by the storage access system. Having the database memory transmit only required portions of the database reduces the latency until the required data portions are transmitted. In some embodiments of the invention, the database memory accumulates requests for data over a short period and then transmits the requested data together.

An aspect of some embodiments of the present invention relates to a storage access system in which different portions of a database are distributed to execution blocks on different internal data buses at different, respective, repetition cycles. Optionally, the storage access system comprises a plurality of links, e.g., data buses, on which the different portions are distributed. Optionally, the storage access system determines which portions of the database are transmitted on each of the data buses, for example according to statistics on the retrieval frequencies of the portions of the database. For example, popular database portions are transmitted on a bus with a relatively high repetition rate, while less popular portions are transmitted on buses with a lower repetition rate.

An aspect of some embodiments of the present invention relates to a storage access system which includes at least one data bus which is used to provide data segments of the database responsive to specific data requests. The at least one bus for providing data segments responsive to data requests is in addition to one or more data buses which are used for repeatedly transmitting a first portion of the database to execution blocks the retrieval elements. In some embodiments of the invention, the at least one bus for providing data segments responsive to requests is used to convey data segments not included in the first portion. Alternatively or additionally, the at least one bus for providing data segments responsive to requests is used to provide segments which are required urgently, for example, for high quality of service (QoS) clients. In some embodiments of the invention, the data segments not repeatedly transmitted on the at least one bus comprise segments which are expected to be required less frequently than those repeatedly transmitted on one or more data buses.

An aspect of some embodiments of the present invention relates to a storage access system which includes execution blocks that have respective internal caches. Queries directed to the storage access system are forwarded to the various execution blocks for resolving.

In some embodiments of the invention, one or more cache-updating data buses are used to transmit data which is to be stored in the internal cache, from a memory unit of the system to the execution blocks. Optionally, the one or more cache-updating data buses are used also for other tasks, for example for providing data segments upon request. Possibly, the one or more cache-updating data buses are in addition to one or more distribution links which repeatedly sweep portions of the database to the execution blocks.

In some embodiments of the invention, substantially all the execution blocks have internal caches. Optionally, all the caches store the same data contents. Alternatively, the caches of different execution blocks carry different data portions.

An aspect of some embodiments of the invention relates to a database server which includes a local area network for communicating between front end input unit and execution units of the database server and/or between the execution units. Optionally, the local area network comprises an ATM network and/or an Ethernet network. The use of local area networks allows using standard and modular communication apparatus for the inner communication of a database machine.

There is therefore provided in accordance with an embodiment of the present invention, a method of resolving a plurality of database queries, comprising accumulating a plurality of queries, determining overlapping portions of the queries that relate to one or more common data attributes, resolving at least two of the determined overlapping portions of the queries together, and preparing responses to the queries based on the resolution of the at least two overlapping portions.

Optionally, determining overlapping portions comprises determining single condition query portions and/or single attribute query portions.

Optionally, determining overlapping portions comprises determining portions including reference to a same attribute but with different constant values.

Optionally, resolving at least two of the determined overlapping portions of the queries together comprises resolving by passing over the data attributes fewer times than required to resolve the overlapping portions separately. Optionally, resolving at least two of the determined overlapping portions of the queries together comprises resolving by passing over the data attributes fewer times than the number of overlapping portions, possibly resolving by passing over the data attributes the same number of times as required for resolving a single one of the overlapping portions. Optionally, resolving at least two of the determined overlapping portions of the queries together comprises resolving by passing over the data attributes once.

Optionally, resolving at least two of the determined overlapping portions of the queries together comprises sweeping the one or more data attributes through one or more filters carrying the overlapping portions of the queries.

Optionally, the method includes placing the values of the overlapping portions in a hash structure and resolving the overlapping portions by searching for at least some of the tuples of the data attribute in the hash structure.

Optionally, the method includes placing the values of the overlapping portions in a content associated memory (CAM) and resolving the overlapping portions by searching for at least some of the tuples of the data attribute in the CAM.

Optionally, the method includes sorting the overlapping portions prior to resolving the overlapping portions. Optionally, determining the overlapping portions comprises parsing at least some of the received queries into query fragments, and accumulating the query fragments into one or more groups relating to one or more common data attributes. Optionally, preparing responses to the queries comprises preparing a response for at least one query based on results from resolving a plurality of different query fragments.

Optionally, accumulating the query fragments into one or more groups comprises accumulating query fragments of a single data attribute into a plurality of groups which differ in their comparison condition. Optionally, the method includes determining whether the received queries comprise query fragments of predetermined types and wherein parsing at least one of the received queries comprises parsing only queries which are formed of query fragments of the predetermined types.

Optionally, resolving the overlapping portions comprises resolving substantially all the overlapping portions of the accumulated queries that relate to a single group of one or more data attributes, for each tuple, in a single processor cycle of a resolving database server. Optionally, resolving the overlapping portions comprises retrieving at least some of the tuples of the one or more common data attributes from a memory unit in which the data attributes are stored only once. Optionally, resolving the overlapping portions comprises retrieving the at least some of the tuples consecutively and comparing the value of at least one of the retrieved tuples to a plurality of the overlapping portions before retrieving a subsequent tuple.

There is further provided in accordance with an embodiment of the present invention, a query resolving system, comprising a plurality of query resolving units that differ in at least one of processing power, memory size, internal structure and resolution methods; and a controller adapted to receive queries and direct each of the received queries to one or more of the query resolving units.

Optionally, the plurality of resolving units differ in the types of queries they are capable of resolving. Optionally, the plurality of resolving units include at least one cache aware unit and at least one unit that is not cache aware. Optionally, the plurality of resolving units include units that differ in the search methods they perform. Optionally, at least one unit is adapted to perform binary searches and at least one other unit is adapted to perform tree searches. Optionally, the plurality of query resolving units comprise at least one unit which includes a CAM memory. Optionally, the plurality of query resolving units comprise a plurality of software units adapted to perform different tasks, running on a single processor.

Optionally, the controller determines to which query resolving units to direct the received queries responsive to the number of tuples which need to be scanned in order to resolve the queries. Optionally, the controller determines to which query resolving units to direct the received queries responsive to whether the attributes related to by the received queries are ordered. Optionally, the controller determines to which query resolving units to direct a received query responsive to a type of the received query. Optionally, the controller determines to which query resolving units to direct a received query responsive to a condition of the received query. Optionally, the controller determines to which query resolving units to direct a received query responsive to the available indices for the data referenced by the received query. Optionally, the received queries comprise single condition queries.

There is further provided in accordance with an embodiment of the present invention, a method of resolving database queries, comprising receiving one or more queries, selecting a method for resolving the one or more queries, from a plurality of available methods, and providing the one or more queries to a resolution unit selected responsive to the selected method.

Optionally, selecting the method for resolving the one or more queries comprises selecting a method according to at least one parameter of the data segments to which the one or more queries relate. Optionally, selecting the method for resolving the one or more queries comprises selecting a method responsive to an amount of data which must be reviewed in order to resolve the one or more queries.

Optionally, selecting the method for resolving the one or more queries comprises selecting a method responsive to whether the data which must be reviewed in order to resolve the one or more queries is ordered. Optionally, selecting the method for resolving the one or more queries comprises selecting responsive to the types of indices available for the data referenced by the queries. Optionally, selecting the method for resolving the one or more queries comprises selecting a search method. Optionally, receiving the one or more queries comprises receiving a plurality of single condition queries. Optionally, receiving the one or more queries comprises receiving one or more queries that compile into a plurality of directives. Optionally, the method includes compiling the received one or more queries according to the selected method.

There is further provided in accordance with an embodiment of the present invention, a storage access system, comprising a database memory, a database server adapted to resolve database commands of a plurality of different types, based on the contents of the database memory, and a database server accelerator adapted to resolve at least some of the types of database requests which the database server is adapted to resolve, based on data cached from the database memory, but is not capable of handling at least one type of database request that the database server is adapted to resolve.

Optionally, the accelerator is not capable of handling database updates. Optionally, the accelerator is not capable of handling database requests relating to certain portions of the database. Optionally, the accelerator is not capable of handling database queries having a complex format. Optionally, the storage access system includes a load balancer which receives database requests directed to the memory and forwards each request to the accelerator or to the server responsive to the capabilities of the accelerator and responsive to other load balancing considerations. Optionally, the accelerator forwards database requests it cannot handle to the database server.

There is further provided in accordance with an embodiment of the present invention, a database server accelerator, comprising a plurality of memory units, adapted to cache data from a database accelerated by the accelerator, a plurality of respective query execution machines, adapted to resolve database queries using data cached in their respective memory unit, each memory unit being accessible by its respective execution machine and not by other execution machines, and a resource governor adapted to determine the data to be cached in each of the plurality of memory units.

Optionally, the accelerator includes a query dispatcher adapted to provide queries to the plurality of query execution machines.

Optionally, the dispatcher is adapted to provide at least some of the queries to a plurality of execution machines which jointly resolve each of the queries. Optionally, the query dispatcher is adapted to select one or more query machines to perform a query, according to the data referred to by the query and the data stored in the memory units. Optionally, at least one of the execution machines comprises a plurality of processors.

Optionally, each of the plurality of processors of a specific execution machine can access all the address space of the respective memory unit of the execution machine. Optionally, at least one of the processors of a specific execution machine can access only a portion of the address space of the respective memory unit of the execution machine.

Optionally, at least two of the execution machines have different processing powers.

Alternatively, all the execution machines have the same processing power. Optionally, at least two of the memory units have different storage space. Alternatively, all the memory units have the same storage space. Optionally, at least two of the execution machines are adapted to resolve different types of queries. Optionally, the resource governor is adapted to have each memory unit cache data not stored in any of the other memory units. Alternatively, the resource governor is adapted to have at least two memory units cache the same data

Optionally, the accelerator includes a compiler adapted to convert queries provided to a plurality of the execution machines into operator statements executable by the machines.

There is further provided in accordance with an embodiment of the present invention, a query resolving system, comprising an input interface adapted to receive queries, a data identifier which is adapted to convert the received queries into query fragments and to identify which data segments are required in order to resolve the query fragments, one or more execution blocks adapted to resolve query fragments, a data storage unit which stores a plurality of data segments, at least one high speed link which connects the data storage unit to the one or more execution blocks, and a data sweeping unit which selectively sweeps data segments over the at least one high speed link to the one or more execution blocks, responsive to the identification of the data identifier.

Optionally, the one or more execution blocks comprise a plurality of execution blocks which resolve different queries concurrently. Optionally, at least one of the one or more execution blocks is adapted to receive a batch of a plurality of query fragments and to resolve the plurality of query fragments concurrently. Optionally, the data identifier is adapted to parse multiple condition queries into single condition queries. Optionally, the at least one high speed link comprises a bus.

There is further provided in accordance with an embodiment of the present invention, a storage access system, comprising a memory adapted to store a database, one or more data links, at least one data sweeping unit which repeatedly transmits different portions of the database at different respective rates on the one or more data links, and a plurality of execution blocks adapted to receive database requests and respond to the requests based on data transmitted on the data links.

Optionally, at least one of the execution blocks comprises an associated cache which stores a portion of the database Optionally, the portion of the database stored in the cache is not transmitted on the one or more data links. Optionally, at least two of the execution blocks have caches which contain different portions of the database. Optionally, the storage access system includes a controller which determines which portions of the database are transmitted at which respective rates, responsive to statistics on the number of queries related to each of the data portions.

Optionally, the controller determines that highly popular portions of the database are transmitted more frequently than data portions with a lower popularity.

There is further provided in accordance with an embodiment of the present invention, a storage access system, comprising a memory adapted to store a database, one or more data links, at least one data sweeping unit which repeatedly transmits portions of the database on the one or more data links, a plurality of execution blocks adapted to respond to database requests, and at least one cache memory associated with at least one of the plurality of execution blocks, the execution blocks respond to at least some of the requests based on data transmitted on the data links and to at least some of the requests based on data in the at least one cache.

Optionally, the data sweeping unit is adapted to transmit updates for the contents of the at least one cache memory over the one or more data links.

There is further provided in accordance with an embodiment of the present invention, a storage access system, comprising a memory adapted to store a database, at least one data link, a data sweeping unit which repeatedly transmits data on the at least one link, a plurality of data execution blocks adapted to receive database requests and respond to the requests based on data transmitted on the at least one link, and a controller which identifies database portions required by at least one of the database requests and transmits the required portions on the at least one data link.

Optionally, the controller receives database requests directed to the system and forwards the requests to the execution blocks. Optionally, the controller identifies required database portions by receiving requests from the execution blocks. Optionally, the required database portions comprise portions not repeatedly transmitted by the data sweeping unit.

There is further provided in accordance with an embodiment of the present invention, a method of resolving data base queries by a system including a plurality of execution blocks, comprising receiving a plurality of queries, selecting for each query one of the plurality of execution blocks to resolve the query, and transmitting at least some of the queries to their respective selected execution blocks over a local area network.

Optionally, transmitting the at least some of the queries to their respective selected execution blocks comprises transmitting over an ATM network and/or an Ethernet network.

There is further provided in accordance with an embodiment of the present invention, a database server system, comprising an input unit adapted to receive database commands, a plurality of database command handling units, and a local area network connecting the input unit to the database command handling units.

Optionally, the database command handling units comprise query resolving units.

There is further provided in accordance with an embodiment of the present invention, a database server accelerator, comprising a memory unit, adapted to cache data from a database accelerated by the accelerator, at least one query execution machine, adapted to resolve database queries using data cached in the memory unit, and a resource governor adapted to determine the data to be cached in the memory unit, at least partially responsive to the quality of service of queries previously directed to the accelerator or by the accelerated database.

Optionally, the resource governor is adapted to determine the data to be cached, at least partially responsive to the quality of service of queries recently directed to the accelerator or by the accelerated database.

There is further provided in accordance with an embodiment of the present invention, a method of resolving a database query, comprising receiving one or more queries, determining the quality of service (QoS) ranking of the query, and determining a handling course of the query responsive to the determined QoS ranking.

Optionally, determining the QoS ranking of the query comprises determining according to a client label and/or according to a source of the query. Optionally, determining the handling course comprises performing a single-query session for high QoS queries and a batch-query session for low QoS queries.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a storage access system, in accordance with some embodiments of the present invention;

FIG. 2 is a flowchart of the acts performed by a controller of a storage access system, in accordance with an embodiment of the present invention;

FIG. 3 is a schematic block diagram of a database server system, in accordance with some embodiments of the present invention;

FIG. 4 is a schematic block diagram of a database server accelerator, in accordance with an embodiment of the present invention;

FIG. 5 is a flowchart of the acts performed by a database server accelerator in handling a database query, in accordance with an embodiment of the present invention; and

FIG. 6 is a schematic block diagram of a query resolution unit, in accordance with an embodiment of the present invention.

### DETAILED DESCRIPTION OF EMBODIMENTS

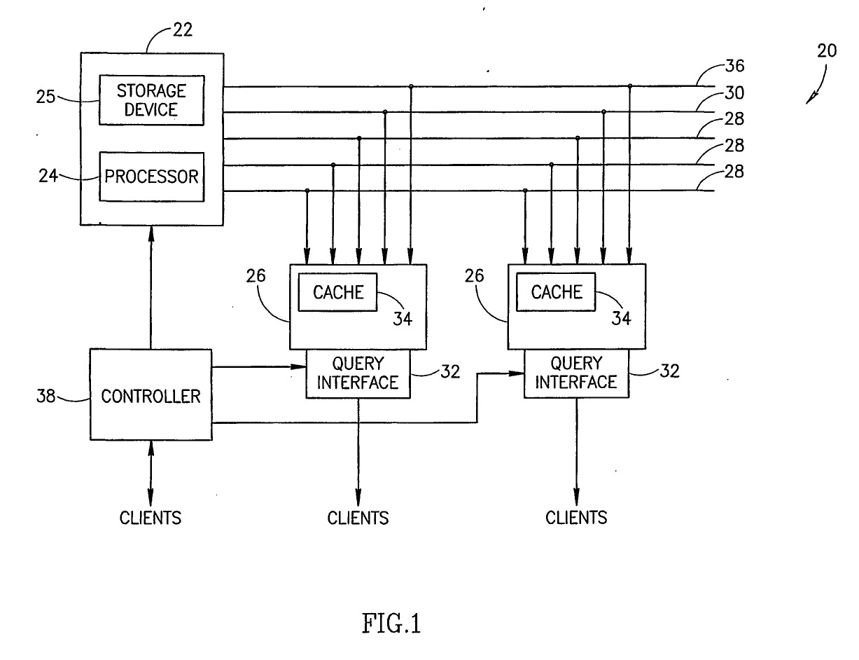

FIG. 1 is a schematic illustration of a storage access system 20, in accordance with an embodiment of the present invention. Storage access system 20 comprises a sweeping unit 22 which stores a database (or a plurality of databases). The database may include files of an Internet web site, records of a relational database or any other information which is to be provided to clients. In some embodiments of the invention, sweeping unit 22 comprises a general purpose processor 24 and one or more storage devices 25, such as magnetic disks.

Storage access system 20 comprises a plurality of execution blocks 26 which resolve data requests directed to system 20. In some embodiments of the invention, a controller 38 receives requests from clients and distributes the requests between execution blocks 26. Optionally, controller 38 also receives the responses to the requests from execution blocks 26 and transmits the responses to the clients. Alternatively or additionally, the responses are returned directly from execution blocks 26 without passing through controller 38. Execution blocks 26 optionally comprise query interfaces 32 through which they receive user queries and transmit responses to the resolved queries.

In some embodiments of the invention, execution blocks 26 comprise dedicated hardware elements. Alternatively or additionally, execution blocks 26 comprise ASIC elements. Further alternatively or additionally, one or more of execution blocks 26 comprises a processor, for example a network processor, which runs a software.

Sweeping unit 22 is optionally connected to one or more data buses 28 on which it repeatedly transmits respective portions of the database. In some embodiments of the invention, execution blocks 26 listen to the data transmitted on the plurality of data buses 28 and use this data to respond to received requests. In some embodiments of the invention, storage access system 20 further comprises a response bus 30 on which sweeping unit 22 provides data not currently provided repeatedly on data buses 28.

Generally, the cost of an execution block 26 is much lower than the cost of sweeping unit 22. By using a single sweeping unit 22 with a large number of execution blocks 26, a large number of requests can be handled in a given time, at a relatively low cost. Generally, a single sweeping unit 22 can operate with any number of execution blocks 26. The number of data requests which can be handled by sweeping unit 22 increases with the number of execution blocks 26 in system 20. Generally, system 20 is highly cost effective for databases which receive a large number of data requests per data segment. In addition, system 20 is modular, as it allows to increase the number of execution blocks 26 with the increase in the number of queries handled by the system.

In some embodiments of the invention, one or more of execution blocks 26 includes a cache 34 in which some of the contents of the database are stored. Optionally, caches 34 store the most commonly used data in the database. Optionally, a cache update bus 36 is used to transmit updates of data in one or more of caches 34 and/or replacement data segments from sweeping unit 22 to the caches. Alternatively or additionally, data directed to caches 34 is transmitted on response bus 30. Buses 28, 30 and 36 may comprise separate physical buses or may comprise separate logical portions (channels and/or slots) on one or more common physical buses.

In some embodiments of the invention, each of data buses 28 has a predetermined data amount which is repeatedly transmitted on the respective data bus 28 with a respective time cycle. In some embodiments of the invention, each bus 28 has a different time cycle in which it repeatedly transmits its data.

In some embodiments of the invention, controller 38 organizes the contents of the database of system 20 in a hierarchy that determines which data segments are held in caches 34, which data segments are to be transmitted on each of data buses 28 and which data segments are only provided when required, on response bus 30. In some embodiments of the invention, each data segment has a popularity rating which determines the position of the data segments in the hierarchy. Optionally, data segments with highest popularity ratings are stored in caches 34. Data segments with next highest popularity ratings are repeatedly transmitted on data buses 28. Optionally, data segments with higher popularity ratings are transmitted on data buses 28 with shorter repetition time cycles. Data segments with low popularity ratings are transmitted on response bus 30 when they are required.

In some embodiments of the invention, the popularity rating of a data segment designates the number of times the data segment was required during a predetermined period. Optionally, requests occurring more recently are given higher weight in the popularity rating than earlier requests. Alternatively or additionally, data segments referenced by high quality of service (QoS) queries are given higher weight, thus giving higher popularity rates referenced by high QoS queries. In some embodiments of the invention, queries are considered having a high QoS when they are received from high QoS users. Alternatively or additionally, queries are considered having a high QoS if they have a specific format, e.g., a simple format.

In some embodiments of the invention, the hierarchy organization is performed once before the startup of storage access system 20 and/or periodically (e.g., every day, week or month). Alternatively, the hierarchy organization is performed dynamically according to statistics generated based on currently received queries. Optionally, before, in parallel to and/or after providing queries to execution blocks 26, controller 38 determines to which data segments they relate and accordingly updates the statistics it accumulates. When a data segment in a low level of the hierarchy has a higher popularity rating than a data segment in a higher level, the positions of the data segments in the hierarchy are optionally switched. In some embodiments of the invention, changes in the positions of data segments in the hierarchy are performed only at predetermined intervals (e.g., every 5-10 seconds), in order to prevent changes from occurring too often. Alternatively or additionally, changes in the hierarchy are performed only when the difference in the popularity ratings between the replaced data segments is greater than a predetermined margin value.

In some embodiments of the invention, when a data segment lowest in the hierarchy level, i.e., not currently transmitted on data buses 28, is requested by one or more of execution blocks 26, controller 38 moves the data segment into transmission on one of data buses 28, optionally on the data bus 28 with the longest time cycle. A different data segment is removed from the data bus 28 in order to make room for the newly requested data segment. The data segment removed from the bus 28 is selected using any criteria known in the art, such as the least recently used (LRU) or least recently posted criteria. In some embodiments of the invention, a data segment may move up or down in the hierarchy based on popularity ratings of related data segments. For example, a web page may be moved up in the hierarchy when pages referencing the page become popular.

In some embodiments of the invention, requests to update the database are handled by controller 38. Optionally, when a data segment within one or more of caches 34 is updated, an update message is transmitted to the caches 34 on cache update bus 36. Methods for keeping the database updated while execution blocks 26 resolve queries are described, for example, in the above-mentioned U.S. Pat. No. 5,230,073.

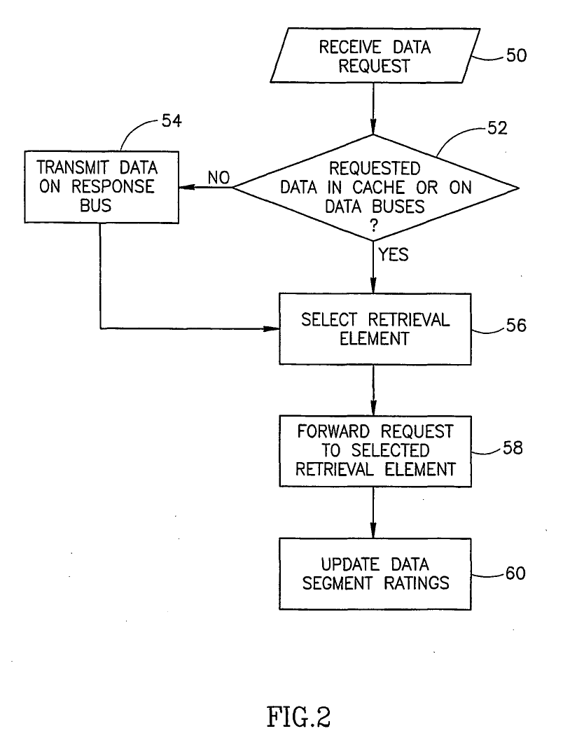

FIG. 2 is a flowchart of the acts performed by controller 38, in accordance with an embodiment of the present invention. When a request for data is received (50), controller 38 determines (52) whether all the data required for resolving the request is available on data buses 28 and/or in the cache 34 of at least one of execution blocks 26. If the required data is not on data buses 28 and/or in one of caches 34, controller 38 transmits (54) the missing data on response bus 30. Controller 38 selects (56) a execution block 26 to handle the data request and forwards (58) the request to the selected execution block. In some embodiments of the invention, controller 38 updates (60) the popularity ratings of the data segments responsive to the received request.

Alternatively to determining (52) by controller 38 whether all the data required for the received requests is available to execution blocks 26, the determination is performed by the execution block 26 receiving the request. Optionally, if the execution block 26 determines that it requires data not available on data buses 28 or in its cache 34 it requests the data from controller 38, which responsive thereto transmits the data on response bus 30.

Referring in more detail to transmitting (54) the missing data on response bus 30, in some embodiments of the invention, the missing data is transmitted on the data bus for a predetermined number of times. Such repeated transmission is useful in case other requests requiring the same data are received shortly after the data which caused the transmission of the missing data was received, as is commonly the case. Alternatively or additionally, the repeated transmission is used to ensure that the data was received by the relevant execution block 26. Alternatively, the requested data is repeatedly transmitted on response bus 30 at a predetermined repetition cycle time until the bandwidth of response bus 30 is required for more needed data segments. Further alternatively or additionally, execution blocks 26 send acknowledgment messages to controller 38 after the received missing data is received. Optionally, different data segments are transmitted on response bus 30 at different data rates according to an estimated importance of the data segment. In some embodiments of the invention, the missing data is transmitted on response bus 30 immediately when the request is forwarded to a execution block 26, before repeated transmission of other data which was already transmitted on response bus 30.

In some embodiments of the invention, when controller 38 identifies an urgent request which requires a data segment which is circulated on one of data buses 28 at a relatively slow rate, the controller immediately transmits the data segment on response bus 30.

Referring in more detail to selecting (56) the execution block 26 to handle a request, in some embodiments of the invention, the selection is performed in a manner which attempts to achieve substantially equal load on execution blocks 26. The selection may be performed, for example, using substantially any suitable load balancing method. In some embodiments of the invention, different execution blocks 26 handle different types of requests or are preferred for different types of requests. For example, different execution blocks 26 may have different contents in their cache 34. Alternatively or additionally, different execution blocks 26 may be connected to different data buses 28. Accordingly, a suitable execution block 26 is selected for the specific request.

Optionally, data buses 28 do not repeatedly carry segments of the database. Instead, when a request for a data stream is received, sweeping unit 22 transmits the requested data stream on one of buses 28. The request is forwarded to one of execution blocks 26 which removes the data stream from the bus 28 and forwards the stream to the client. Optionally, short and/or popular data streams are stored in caches 34.

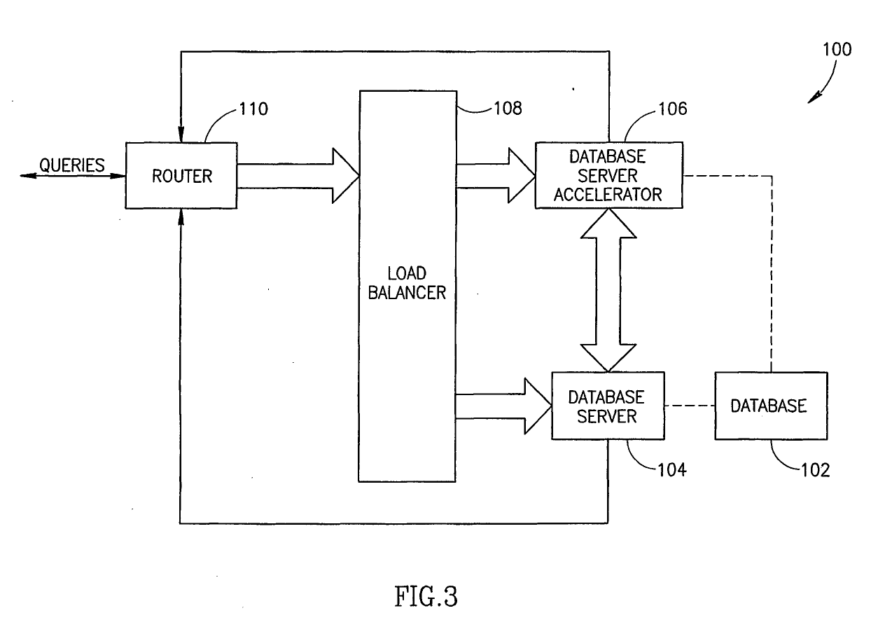

FIG. 3 is a schematic block diagram of a database server system 100, in accordance with some embodiments of the present invention. System 100 comprises a database 102 which is stored on a storage means, for example a disk. Database 102 may be a relational database or any other type of database. A database server 104 of any type known in the art uses database 102 to respond to database queries. In addition to database server 104, system 100 includes a database server accelerator 106 which enhances the number of queries to which system 100 can respond in a given time. In some embodiments of the invention, accelerator 106 has limited capabilities relative to database server 104 and can handle only a subset of the queries that can be resolved by database server 104. Optionally, accelerator 106 can resolve only queries having a relatively simple structure, for example queries not requiring string operations. Alternatively or additionally, accelerator 106 can resolve only queries which relate to a specific portion of database 102. Further alternatively or additionally, accelerator 106 does not perform database updates.

Optionally, the queries generally handled by system 100 are analyzed and accordingly it is determined which tasks are to be supported by accelerator 106. The analysis may be performed before the installation of accelerator 106 and/or periodically.

In some embodiments of the invention, system 100 comprises a load balancer 108 which receives database queries, for example through a router 110. Optionally, load balancer 108 forwards queries which can be handled by accelerator 106 to the accelerator and all other queries to database server 104. Alternatively or additionally, load balancer 108 uses other load balancing rules in order to optimize the handling of queries received by database system 100. Alternatively to using load balancer 108, all queries are forwarded to accelerator 106 which operates as a load balancer, i.e., resolves some of the queries by itself and forwards the remaining queries to database server 104. The responses to the queries forwarded from accelerator 106 to database server 104 may pass through the accelerator or may be forwarded directly to the source of the query, e.g., through router 110.

In some embodiments of the invention, a plurality of accelerators 106 are connected to a single database server 104. The plurality of accelerators 106 are optionally identical accelerators which are used to enhance the capabilities of system 100. Alternatively or additionally, the plurality of accelerators 106 comprise different types of accelerators, which for example can handle different types of queries. Further alternatively or additionally, a single accelerator 106 is used to enhance the operation of a plurality of database servers 104.

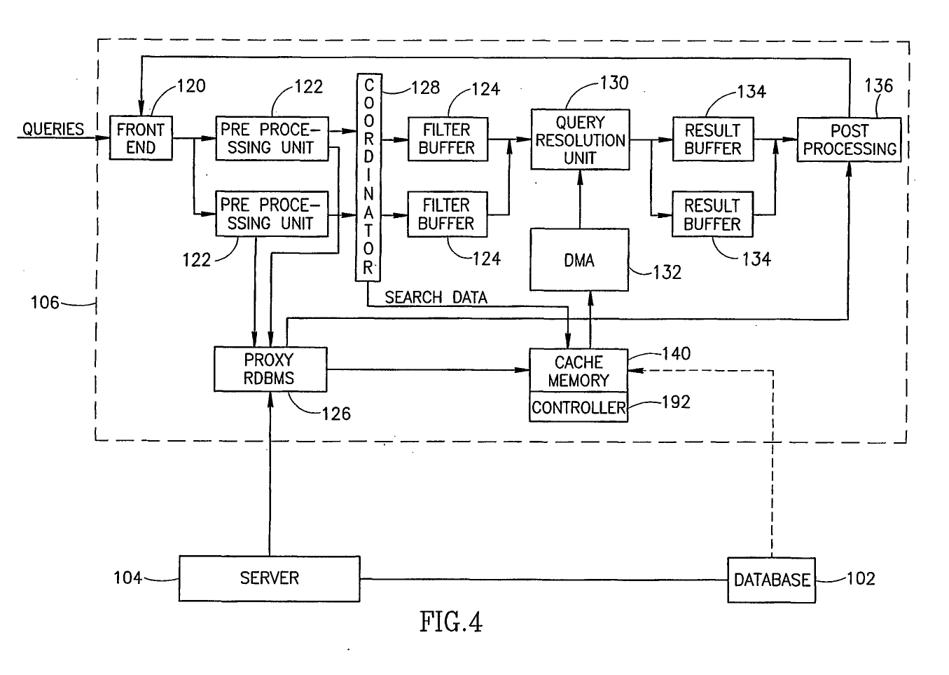

FIG. 4 is a schematic block diagram of accelerator 106, in accordance with an embodiment of the present invention. Optionally, accelerator 106 comprises a front end 120 which receives database queries. The received queries may be in accordance with any query language, for example, the Structured Query Language (SQL) and/or the Extendible Markup Language (XML). Optionally, front end unit 120 may receive queries in accordance with a plurality of different query languages and translates the queries into a single query language with which accelerator 106 operates. The received queries are forwarded to one or more preprocessing units 122 which prepare the received queries for resolving. In; some embodiments of the invention, preprocessing unit 122 breaks the received queries into query fragments, as described hereinbelow, and the query fragments are forwarded to one or more buffers 124 in which the query fragments are accumulated for processing. In some embodiments of the invention, the preprocessing units 122 compile the queries into executable operator segments, as is known in the art, before or after breaking the queries into fragments.

Optionally, queries which include query fragments that cannot be resolved by accelerator 106 are forwarded in their entirety to database server 104. Alternatively or additionally, query fragments which cannot be processed by accelerator 106 are forwarded to database server 104, which resolves these query fragments. Optionally, accelerator 106 includes a database server interface (not shown) that queries database server 104 for the results of these queries and/or query fragments.

In some embodiments of the invention in which accelerator 106 includes a plurality of preprocessing units 122, a coordinator 128 (referred to also as a dispatcher and resource governor) combines the single attribute queries from the different preprocessing units 122, optionally, into a desired order, e.g., an order useful or required for query resolution. In some embodiments of the invention, accelerator 106 includes two or more buffers 124 which are used for pipeline operation. While one of buffers 124 accumulates query fragments, the other buffer 124 is used to provide the queries for resolving, and vice versa. In some embodiments of the invention, a query resolution unit 130 (referred to also as an executor) receives the query fragments from buffers 124 and together resolves the query fragments with relation to a portion of database 102 stored in a cache memory 140. The results of the query fragments are provided from query resolution unit 130 to one or more result buffers 134. Optionally, for pipeline operation two or more result buffers 134 are used.

A post processing unit 136 uses the results in result buffers 134 in order to generate results of the parsed queries. Optionally, post processing unit 136 also uses results from the database server interface and/or data from cache memory 140. In some embodiments of the invention, result buffer 134 carries pointers to the results (e.g., row numbers in a database table) and the results themselves are retrieved from cache memory 140 by post processing unit 136.

In some embodiments of the invention, accelerator 106 comprises a data transfer unit 132 which transfers data from cache memory 140 to query resolution unit 130 according to the specific query fragments resolved by resolution unit 130. In some embodiments of the invention, data transfer unit 132 comprises one or more direct memory access (DMA) units. Optionally, data transfer unit 132 includes an internal cache memory which holds data excerpts from cache memory 140 and/or data which is currently provided to query resolution unit 130. Alternatively or additionally to data transfer unit 132 providing data to query resolution unit 130, some of the sub-units of query resolution unit 130 or query resolution unit 130 in its entirety, accesses the data directly in cache memory 140.

Optionally, cache memory 140 comprises a controller 192 which keeps the contents of cache memory 140 updated. In some embodiments of the invention, cache memory 140 includes predetermined portions of database 102 which are most commonly used. Alternatively, cache memory 140 includes periodically updated portions of database 102, for example based on on-line statistical data on the use of portions of the database. Alternatively or additionally, when preprocessing unit 122 identifies a relatively large number of single attribute queries directed to data not included in cache memory 140, controller 192 loads the required data to cache memory 140. Further alternatively, cache memory 140 carries database 102 in its entirety.

In some embodiments of the invention, at startup of accelerator 106, controller 192 uploads portions of database 102 into cache memory 140. Optionally, the portions of database 102 which are uploaded are selected as the most popular portions, i.e., the portions which are required for the most queries. Possibly, the determination of which portions of database 102 are uploaded is performed based on user configured data. Alternatively or additionally, the determination is performed based on accumulated statistics generated by load balancer 108 (FIG. 3).

During the operation of accelerator 106, controller 192 optionally keeps the contents of cache memory 140 consistent with database 102. In some embodiments of the invention, controller 192 listens to update commands transmitted to database 102. If the update commands relate to data in cache memory 140, controller 192 changes the contents of cache memory 140 according to the update command. Alternatively or additionally, an update client sitting on database 102 and/or on database server 104 sends update commands to controller 192. Further alternatively or additionally, controller 192 periodically queries database 102 directly, through database server 104 and/or through a database proxy 126, to update the contents of cache memory 140. Further alternatively or additionally, any other method known in the art for keeping databases consistent, is used.

In some embodiments of the invention, when the usage statistics of the contents of database 102 change, controller 192 retrieves segments of the database which became popular, for example through proxy 126, and less popular segments are discarded from cache memory 140.

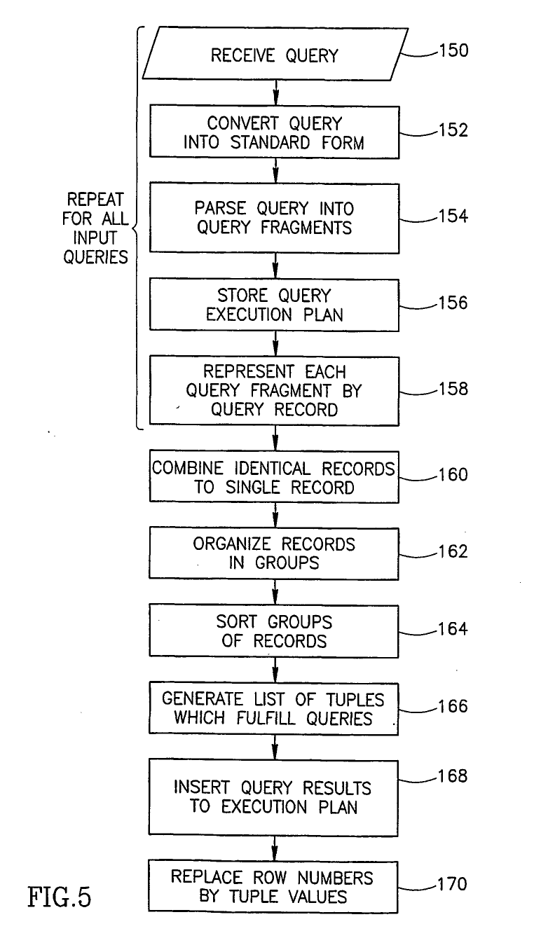

FIG. 5 is a flowchart of the acts performed by accelerator 106 in handling a database query, in accordance with an embodiment of the present invention. As described above, front end 120 receives (150) the query and passes it to a preprocessor 122. Optionally, front end 120 receives the queries in a format suitable for external transmission, e.g., with an IP header, and the front end converts the query to a format suitable for internal use in accelerator 106, e.g., removes the IP header.

In some embodiments of the invention, preprocessor 122 converts (152) the received queries into a standard form. Optionally, the conversion of the queries includes converting the queries into a form which includes only certain types of query fragments. For example, the conversion may includes changing ‘greater than or equal’ operations into ‘smaller than’ operations with a ‘not’ operator. Alternatively or additionally, the conversion of the queries includes resolving ‘not’ operations which are applied to complex expressions, for example using De Morgan's laws. Further alternatively or additionally, the conversion of the queries includes dividing range query fragments (e.g., 3<A<5) into separate single condition fragments (A<5).

Preprocessor unit 122 breaks (154) the queries into query fragments. Optionally, breaking the queries into query fragments comprises breaking into single condition queries. For example, given a query:

(A>3 AND B<6 AND C=4) OR (A<1 AND NOT(B=5))

in which A, B and C represent attributes of one or more tables in the database, preprocessor 122 breaks the query into five single attribute queries (1) A>3, (2) B<6, (3) C=4, (4) A<1 and (5) B=5. In addition, preprocessor unit 122 stores (156) for each query the structure of the query (referred to herein as the execution plan) with references to the single attribute queries to which it pertains:

((1) AND (2) AND (3)) OR ((4) AND NOT(5)).

Optionally, the query structure is passed to post processing unit 136 which determines the final results of the query by inserting the results of resolving the query fragments by query resolution unit 130 into the query structure.

Alternatively or additionally, other query optimization acts known in the art are applied to the queries and/or query fragments by preprocessing unit 122. For example, the query may be processed so as to change the order of operations performed, e.g., so that select operations are performed before Join operations.

Optionally, preprocessor 122 examines the structure of each query fragment to determine whether the fragment has a structure which can be handled by query resolution unit 130. Fragments of forms which cannot be handled by query resolution unit 130 are optionally passed to database server 104 for external resolution. Alternatively, queries including fragments which cannot be resolved by query resolution unit 130, are passed by preprocessor 122 in their entirety to database server 104 or are rejected by accelerator 106.

In some embodiments of the invention, only single attribute queries are resolved by query resolution unit 130, while single condition queries depending on a plurality of attributes are passed to database server 104. Alternatively or additionally, text comparison queries are not handled by query resolution unit 130.

In some embodiments of the invention, preprocessor 122 represents (158) each query fragment by a record that includes fields for the attribute to which the query is applied, the condition which the attribute must fulfill for a match and a query ID. Optionally, the attributes are identified by a table identification and a column identification in the table. In some embodiments of the invention, preprocessor 122 generates three different types of records which differ in the condition they use: greater than, smaller than and equal. The condition field in the generated records takes on the value to which the attribute is to be compared. For example, the records may be of the following form:

| | | |
|---|---|---|
| Attribute ID | Value | Query ID |

Attribute ID. Value Query ID

In some embodiments of the invention, when preprocessor 122 and/or coordinator 128 identify two or more identical records which represent the same query fragment, the records are combined (160) to a single record in which the query ID is replaced by a group ID. Preprocessor 122 optionally generates for each group ID a record which identifies the query fragments which are included in the group.

In some embodiments of the invention, before the queries are loaded into a buffer 124 they are organized (162) into groups according to the attributes to which they pertain and/or the type of the operation of the query (e.g., greater than, smaller than, equal). The groups of queries, thus, include overlapping portions of the fragmented queries. It is noted, however, that the overlapping portions are not necessarily completely overlapping. Rather, the constant portions of the fragments may have different values. In other embodiments of the invention, the conditions may be different.

Each group of queries pertaining to an attribute are optionally sorted (164) according to their value field in order to simplify the resolving of the queries as described hereinbelow. Alternatively, only queries of certain types, for example the greater than and smaller than queries, are sorted.

Alternatively or additionally, preprocessor 122 performs other preparation tasks, such as one or more transaction optimization methods known in the art.

Preprocessor 122 then provides the groups of queries to query resolution unit 130. Optionally, each group is provided with timing instructions which define the order and/or time in which the groups are resolved. In some embodiments of the invention, preprocessor 122 provides data transfer unit 132 with a list of the attributes which are required for each group of queries and the order and/or times in which the query groups are to be resolved. The query execution plans are optionally provided to post processing unit 136 for post processing.

In some embodiments of the invention, query resolution unit 130 resolves the queries by sequentially retrieving each tuple of the one or more attributes to which the group of fragments relate from a memory unit in which the attributes are stored, and comparing the values of the tuple to each of the fragments in the group. Optionally, the comparison for all the query fragments is performed based on the single retrieval of the tuple. In some embodiments of the invention, the subsequent tuple is retrieved from the memory only after substantially all the queries were compared to the present tuple.

For each group of query fragments, query resolution unit 130 generates (166) for each query ID (or group ID) a list of row numbers of tuples which fulfill the query fragment. The operation of query resolution unit 130 is described hereinbelow in detail.

As described above, in some embodiments of the invention, post processing unit 136 receives the query results from query resolution unit 130, through a result buffer 134. Post processing unit 136 inserts (168) the single attribute query results to the execution plans it receives and thus provides lists of tuples which fulfill the original queries. Optionally, ‘AND’ operations of the execution plan are resolved by finding row numbers which appear in both lists. Optionally, ‘OR’ operations are performed by combining the lists of row numbers. For ‘NOT’ operations, post processing unit 136 optionally consults cache memory 140 to determine the number of tuples in the relevant table.

Thereafter, post processing unit 136 optionally queries cache memory 140, to replace (170) the row numbers by the tuples represented by the row numbers. In some embodiments of the invention, the tuples which fulfill the query are forwarded to frond end 120 which prepares the tuples for transmission back to the client which generated the query.

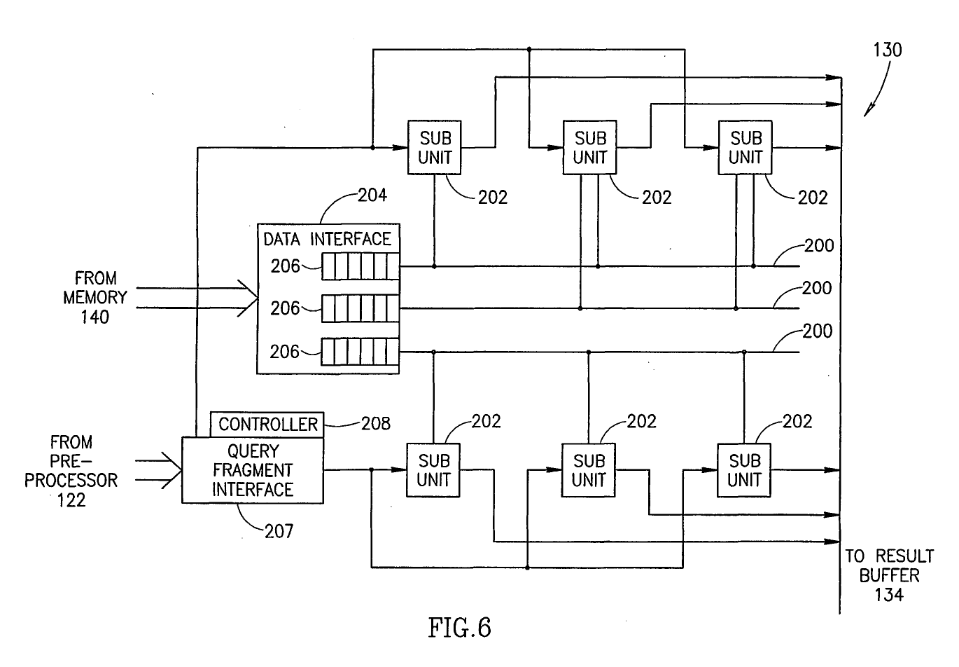

FIG. 6 is a schematic block diagram of query resolution unit 130, in accordance with an embodiment of the present invention. In the embodiments of FIG. 6, query resolution unit 130 comprises a plurality of sub units 202 which perform the resolution of the queries. Optionally, a query fragment interface 207 receives query fragments from preprocessor 122 and/or from coordinator 128 and distributes the query fragments between the sub-units 202. A data interface 204 receives the data from data transfer unit 132 and distributes the data to sub-units 202 through one or more data buses 200.

Generally, each data bus 200 has a respective maximal bandwidth capacity, for example 1 Gbyte/data cycle, wherein the data cycle is the time in which all sub-units 202 review all the data related to their queries, e.g., about 1 second. Data buses 200 may have the same bandwidth capacity or different data buses 200 may have different capacities.

In some embodiments of the invention, a plurality of sub-units 202 are connected on a single data bus 200 to receive the same data Each sub-unit 202 optionally receives up to a predetermined number of query fragments which it can resolve concurrently. Optionally, a number of groups of query fragments of different types are loaded concurrently to sub-units 202, and data transfer unit 132 transmits the relevant attributes concurrently on data buses 200.

Alternatively or additionally, one or more sub-units 202 are connected to a plurality of data buses 200 to allow transmission of more than the maximal capacity of a single bus 200 to the sub-units 202. Further alternatively or additionally, in case a query fragment requires a large amount of data beyond the capacity of a single data bus 200, the query fragment is transferred to a plurality of separate sub-units 202 which resolve the query fragment on separate portions of the relevant data. In some embodiments of the invention, sub-units 202 comprise internal caches in which popular portions of data are stored, as described above with reference to execution blocks 26 of FIG. 1.

In some embodiments of the invention, data interface 204 comprises one or more flow regulation buffers 206 which regulate the data rate of transmission of data on one or more of buses 200. Optionally, each of buses 200 has a respective buffer 206 which regulates the data transmission rate on the bus according to the operation rate of the sub-units 202 connected to the respective buses 200. Alternatively, buffers 206 are used only for buses 200 which lead to slow operating sub-units 202. Alternatively or additionally, preprocessor 122 and/or query resolution unit 130 control the rate at which data transfer unit 132 provides data to interface 204.

In some embodiments of the invention, query resolution unit 130 comprises a plurality of substantially identical sub-units 202 which distribute the load of queries handled by query resolution unit 130. Alternatively or additionally, at least some of sub-units 202 differ in their size, in their internal structure, in the methods they use to resolve queries and/or in the types of queries they resolve.

In some embodiments of the invention, one or more sub-units 202 comprise relatively small units, while other one or more sub-units 202 are relatively large. The small units are optionally used for small batches of queries and/or for queries referencing seldom used data portions.

In some embodiments of the invention, different sub-units 202 are dedicated for resolving different types of queries. Optionally, one or more of sub-units 202 is capable of resolving a plurality of different types of queries. In some embodiments of the invention, subunits 202 comprise one or more equality filters which resolve single attribute queries that involve equality conditions, one or more inequality filters which resolve single attribute filters that involve inequality conditions and/or general purpose filter sub-units which resolve other query types. Alternatively or additionally, query resolution unit 130 comprises other types of sub-units 202, such as text search filters that perform lexicographical searches within strings, tree search units, such as described for example in Israel patent application 145,040, filed August 21, 2001, the disclosure of which is incorporated herein by reference, and/or multiple attribute units that resolve queries which involve comparison of two or more attributes.

Optionally, one or more of sub-units 202 comprises a content associated memory (CAM) which is used to resolve at once a plurality of single attribute equality query fragments. In some embodiments of the invention, the query fragments of one or more groups are loaded into the CAM and the database values of the attribute to which the queries are compared are passed through the CAM which in one cycle determines for each attribute value whether it fulfills each of the query fragments in the CAM.

Alternatively or additionally, one or more of sub-units 202 comprise a dedicated hardware comparator, which resolves a plurality of query fragments concurrently. In some embodiments of the invention, a dedicated hardware comparator receives a sorted list of query fragments relating to the same attribute. Without loss of generality, it is assumed that the query fragments are sorted such that lower values precede higher values. The dedicated hardware comparator resolves all the queries at once by finding, for each attribute value, the location of the attribute value within the sorted query fragments. For equality query fragments, only the matching query fragment of the sorted list (if a matching query fragment exists) is fulfilled by the attribute value. For “smaller than” query fragments, all the query fragments before the matching value are fulfilled by the attribute value. For “greater than” query fragments, all the query fragments after the matching value are fulfilled by the attribute value.

In some embodiments of the invention, different sub-units 202 are used to resolve equality, “greater than” and “smaller than” query fragments relating to the same attribute. Alternatively or additionally, the same sub-unit 202 is used at different times. Further alternatively or additionally, equality and inequality query fragments are resolved together by the same sub-unit 202. Each query fragment in the sorted list is associated with a flag which indicates the condition of the query. In operation, all “greater than” query fragments after the matching query are fulfilled by the attribute and the “smaller than” query fragments before the matching query are fulfilled by the query.

Optionally, one or more sub-units 202 comprise dedicated hardware units for resolving multiple attribute query fragments. For example, the hardware unit may comprise a simple comparator which compares two attribute values and provides an indication on whether the values are equal, “greater than” and/or “smaller than”. The hardware units receives two attributes of each tuple of a relevant table and provides an indication on the relation between them. Alternatively or additionally, one or more of the sub-units 202 comprise software units running on same or different processors. Optionally, the software units comprise functions and/or processes which receive queries of specific structures and resolve the queries using specific methods. Further alternatively or additionally, one or more of sub-units 202 comprise a processor, optionally a simple processor, with appropriate software. The processor may be used to resolve queries not resolvable by other units or may be used to resolve queries that may be resolved by other units, for example to reduce the load on temporarily loaded units. In some embodiments of the invention, still other types of sub-units 202 are used.

In some embodiments of the invention, the sub-units 202 of query resolution unit 130 include a plurality of sub-units that perform the same types of queries using different methods. For example, a first sub-unit 202 may perform searches using a binary search method, while a second sub-unit 202 performs searches using a tree search method and/or a hash search method. Alternatively or additionally, one or more sub-units 202 use cache awareness methods and one or more units that do not use cache awareness methods.

In some embodiments of the invention, query resolution unit 130 comprises a controller 208 that determines for each query and/or group of query fragments, which sub-unit 202 will resolve the query fragments of the group. In some embodiments of the invention, controller 208 selects, for at least some of the queries it receives, a method to resolve the query. According to the selected method, the query is passed to a machine which resolves the query.

In some embodiments of the invention, the method is selected responsive to whether the database attributes which need to be scanned in order to resolve the query are sorted. Alternatively or additionally, the method is selected responsive to the number of tuples including the one or more database attributes to which the query relates. Further alternatively or additionally, the method is selected responsive to the indices available for the data tables referenced by the query. Optionally, the method is selected responsive to the availability of indices for the referenced data, even if some or all of the indices are not referred to in the query.

Alternatively or additionally, controller 208 determines for some or all of the groups of query fragments, which attributes of the data are to be swept in order to resolve the query. According to the determination, the query fragment groups are assigned to sub-units 202. In some embodiments of the invention, controller 208 determines the amount of data which needs to be swept and/or whether the data is ordered. Optionally, query fragments related to unordered data attributes are passed to sub-units 202 which perform sweeping, while query fragments related to ordered data attributes are forwarded, if possible, to sub-units 202 which use searching methods on the ordered data to find the matching tuples.

In addition, controller 208 determines the order in which the groups are resolved in case not all the query fragments can be resolved concurrently. Optionally, the controller uses any load balancing method known in the art, so as to distribute the load evenly between subunits 202. Alternatively or additionally, methods are used to optimize the use of sub-units 202 so that the query fragments are resolved as fast as possible.

In some embodiments of the invention, controller 208 determines for each query fragment group, respective sub-units 202 which can resolve the queries of the group. Optionally, controller 208 additionally determines an indication of the speed at which each sub-unit 202 resolves the queries of the group. For example, some units 202 may be faster for equality query fragments while others are faster for inequality query fragments. Controller 208 optionally assigns the groups to sub-units 202 according to the determinations.

In some embodiments of the invention, the order in which queries are passed to subunits 202 is determined according to the speed at which they are expected to be resolved by the sub-units. Optionally, packets expected to be resolved faster are passed earlier for resolution, so that these queries will receive a fast response and the other queries will not be delayed for long. Alternatively or additionally, packets expected to require more time for resolution are resolved first, so that they are not delayed due to their long execution time. In some embodiments of the invention, one or more sub-units 202 are dedicated for heavy run-time queries and one or more other sub-units 202 are dedicated for use by fast queries.

Alternatively or additionally, at least some of the queries have a quality of service (QoS) rating, and precedence is given to queries with a high QoS. Queries may have a QoS rating, for example, according to the source from which the queries are received and/or according to the data to which they relate. Optionally, when the order is determined for groups, a group QoS is determined as the sum of the QoS ratings of all the queries in the group, and groups with higher group QoS are given precedence. Alternatively or additionally, the QoS of a group is determined as the maximal QoS of a query in the group and/or the number of queries having the maximal QoS.

It is noted that in some embodiments of the invention some of the tasks described above as being performed by controller 208 are performed in conjunction with preprocessor 122 or only by preprocessor 122.

For each query fragment group, the query fragments of the group are loaded into one or more sub-units 202 and the attributes to which the query fragments of the group pertain are transmitted on one or more of data buses 200. Each sub-unit 202 resolves its query fragments for each of the relevant attribute values transmitted on the data buses 200.

In some embodiments of the invention, sub-units 202 are located on a single chip and data buses 200 and/or distribution paths of query fragments to the sub-units are internal to the chip. Alternatively or additionally, sub-units 202 comprise separate units located on a chipset on which data buses 200 are located. Further alternatively or additionally, data buses 200 and/or the paths for distribution of query fragments comprise local area networks (LANs) such as Ethernet and/or ATM networks.

Although in the above description, sub-units 202 of FIG. 6 and execution blocks 26 of FIG. 1 are described as receiving database portions over one or more buses, the delivery of the database portions may be performed using substantially any other communication links. For example, the delivery of the database portions may be performed through a cross bar switch, a shared memory, serial and/or parallel links, and/or any other high speed links. It is noted that the high speed links may be connected using various topologies, for example, line, tree and/or star topologies.

Furthermore, in some of the embodiments of the present invention, sub-units 202 do not perform tasks on data swept on one or more buses, but rather refer to data stored in respective memory units, for example main memory units. The main memory units may be in addition to, or instead of, cache memory 140. Optionally, the one or more buses are used, in these embodiments, to update and/or, load the data into the main memory units. In some of these embodiments, controller 208 selects the sub-unit 202 to resolve a query, also according to the availability of the data referenced by the query, to the sub-units 202.

It is noted that query resolution unit 130 may have many other structures than described with reference to FIG. 6. In an exemplary embodiment of the present invention, query resolution unit 130 comprises a plurality of execution machines, each of which includes one or more processors and a respective memory unit. Optionally, the respective memory units of the execution machines are used instead of cache memory 140. For each batch of query fragments, an execution machine to resolve the query fragments is selected, responsive to the data included in the memory units of the execution machines and/or availability attributes of the execution machines, such as the processing load and/or memory utilization of the machines.

In some embodiments of the invention, a resource governor periodically examines the queries received by system 100 and accordingly determines which data portions are to be cached in each of the memory units. The resource governor optionally determines which data portions should be cached into the memory units at least partially according to the QoS of queries previously received by system 100. Optionally, data portions required by queries having a high QoS are given precedence in being cached by the accelerator and/or by stronger execution machines. The resource governor optionally operates as described in a U.S. provisional patent application titled “Dynamic Information Retrieval System”, and filed on Feb. 21, 2002, under the attorney docket number 254/02475, the disclosure of which is incorporated herein by reference. Alternatively, the resource governor may operate using any other methods known in the art.

In some embodiments of the invention, all of the execution machines include, for simplicity, the same number of processors. In other embodiments of the invention, different execution machines include different numbers of processors, allowing better fitting of different tasks to specific execution machines. The processors may all have the same processing power or may have different amounts of processing power.

In some embodiments of the invention, for simplicity, the capacities of all the memory units are substantially the same. Alternatively, different memory units have different capacities, so as to better fit the different tasks handled by the accelerator. In some embodiments of the invention, the capacities of the memory units are at least partially correlated to the processing power of their respective execution machines, such that execution machines with a relatively high processing power are associated with a relatively large memory unit. In an exemplary embodiment of the invention, some or all of the memory units are of the largest possible size which can be accessed by their respective execution machines.

The plurality of processors within a single execution machine optionally operate in parallel on different queries that relate to the same data Alternatively, the plurality of processors operate in parallel on different queries that relate to different verticals hosted by the memory unit of the execution machine. Further alternatively or additionally, one or more the plurality of processors operate in parallel on different portions or fragments of a single query.

Further alternatively or additionally, any other parallel query processing methods known in the art are used to govern the operation of the processors of a single execution machine. Optionally, the usage of the processors of a single execution machine is controlled by a multi-processor operating system, using methods known in the art.

In some embodiments of the invention, each of the processors of a single execution machine has access to the entire address space of the memory unit associated with the execution machine. Alternatively or additionally, in order to simplify the hardware of the execution machine (e.g., relax the parallelism constraints) each processor has a portion of the memory unit for which it is a sole user.

In some embodiments of the invention, some of the received queries are provided to query resolution unit 130 without fragmentation. For example, high QoS queries may be provided directly to query resolution unit 130 without fragmentation, in order to provide a fast response time, while low QoS queries are resolved in batches, in order to increase throughput of the accelerator.

It will be appreciated that the above described methods may be varied in many ways, including, performing a plurality of steps concurrently, changing the order of steps and changing the exact implementation used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of resolving a plurality of database queries, comprising:
accumulating a plurality of queries;
determining overlapping portions of the queries that relate to one or more common data attributes;
resolving at least two of the determined overlapping portions of the queries together; and
preparing responses to the queries based on the resolution of the at least two overlapping portions.

2. A method according to claim 1, wherein determining overlapping portions comprises determining single condition query portions.

3. A method according to claim 1 or claim 2, wherein determining overlapping portions comprises determining single attribute query portions.

4. A method according to any of the preceding claims, wherein determining overlapping portions comprises determining portions including reference to a same attribute but with different constant values.

5. A method according to any of the preceding claims, wherein resolving at least two of the determined overlapping portions of the queries together comprises resolving by passing over the data attributes fewer times than required to resolve the overlapping portions separately.

6. A method according to any of the preceding claims, wherein resolving at least two of the determined overlapping portions of the queries together comprises resolving by passing over the data attributes fewer times than the number of overlapping portions.

7. A method according to any of the preceding claims, wherein resolving at least two of the determined overlapping portions of the queries together comprises resolving by passing over the data attributes the same number of times as required for resolving a single one of the overlapping portions.

8. A method according to any of the preceding claims, wherein resolving at least two of the determined overlapping portions of the queries together comprises resolving by passing over the data attributes once.

9. A method according to any of the preceding claims, wherein resolving at least two of the determined overlapping portions of the queries together comprises sweeping the one or more data attributes through one or more filters carrying the overlapping portions of the queries.

10. A method according to any of the preceding claims, comprising placing the values of the overlapping portions in a hash structure and resolving the overlapping portions by searching for at least some of the tuples of the data attribute in the hash structure.

11. A method according to any of the preceding claims, comprising placing the values of the overlapping portions in a content associated memory (CAM) and resolving the overlapping portions by searching for at least some of the tuples of the data attribute in the CAM.

12. A method according to any of the preceding claims, comprising sorting the overlapping portions prior to resolving the overlapping portions.

13. A method according to any of the preceding claims, wherein determining the overlapping portions comprises parsing at least some of the received queries into query fragments, and accumulating the query fragments into one or more groups relating to one or more common data attributes.

14. A method according to claim 13, wherein preparing responses to the queries comprises preparing a response for at least one query based on results from resolving a plurality of different query fragments.

15. A method according to claim 13 or claim 14, wherein accumulating the query fragments into one or more groups comprises accumulating query fragments of a single data attribute into a plurality of groups which differ in their comparison condition.

16. A method according to claims 13-15, comprising determining whether the received queries comprise query fragments of predetermined types and wherein parsing at least one of the received queries comprises parsing only queries which are formed of query fragments of the predetermined types.

17. A method according to any of the preceding claims, wherein resolving the overlapping portions comprises resolving substantially all the overlapping portions of the accumulated queries that relate to a single group of one or more data attributes, for each tuple, in a single processor cycle of a resolving database server.

18. A method according to any of the preceding claims, wherein resolving the overlapping portions comprises retrieving at least some of the tuples of the one or more common data attributes from a memory unit in which the data attributes are stored only once.

19. A method according to claim 18, wherein resolving the overlapping portions comprises retrieving the at least some of the tuples consecutively and comparing the value of at least one of the retrieved tuples to a plurality of the overlapping portions before retrieving a subsequent tuple.

20. A query resolving system, comprising:
a plurality of query resolving units that differ in at least one of processing power, memory size, internal structure and resolution methods; and
a controller adapted to receive queries and direct each of the received queries to one or more of the query resolving units.

21. A system according to claim 20, wherein the plurality of resolving units differ in the types of queries they are capable of resolving.

22. A system according to claim 20 or 21, wherein the plurality of resolving units include at least one cache aware unit and at least one unit that is not cache aware.

23. A system according to any of claims 20-22, wherein the plurality of resolving units include units that differ in the search methods they perform.

24. A system according to claim 23, wherein at least one unit is adapted to perform binary searches and at least one other unit is adapted to perform tree searches.

25. A system according to any of claims 20-24, wherein the plurality of query resolving units comprise at least one unit which includes a CAM memory.

26. A system according to any of claims 20-25, wherein the plurality of query resolving units comprise a plurality of software units adapted to perform different tasks, running on a single processor.

27. A system according to any of claims 20-26, wherein the controller determines to which query resolving units to direct the received queries responsive to the number of tuples which need to be scanned in order to resolve the queries.

28. A system according to any of claims 20-27, wherein the controller determines to which query resolving units to direct the received queries responsive to whether the attributes related to by the received queries are ordered.

29. A system according to any of claims 20-28, wherein the controller determines to which query resolving units to direct a received query responsive to a type of the received query.

30. A system according to claim 29, wherein the controller determines to which query resolving units to direct a received query responsive to a condition of the received query.

31. A system according to any of claims 20-30, wherein the controller determines to which query resolving units to direct a received query responsive to the available indices for the data referenced by the received query.

32. A system according to any of claims 20-31, wherein the received queries comprise single condition queries.

33. A method of resolving database queries, comprising:
receiving one or more queries;
selecting a method for resolving the one or more queries, from a plurality of available methods; and
providing the one or more queries to a resolution unit selected responsive to the selected method.

34. A method according to claim 33, wherein selecting the method for resolving the one or more queries comprises selecting a method according to at least one parameter of the data segments to which the one or more queries relate.

35. A method according to claim 34, wherein selecting the method for resolving the one or more queries comprises selecting a method responsive to an amount of data which must be reviewed in order to resolve the one or more queries.

36. A method according to claim 34 or 35, wherein selecting the method for resolving the one or more queries comprises selecting a method responsive to whether the data which must be reviewed in order to resolve the one or more queries is ordered.

37. A method according to any of claims 34-36, wherein selecting the method for resolving the one or more queries comprises selecting responsive to the types of indices available for the data referenced by the queries.

38. A method according to any of claims 33-37, wherein selecting the method for resolving the one or more queries comprises selecting a search method.

39. A method according to any of claims 33-38, wherein receiving the one or more queries comprises receiving a plurality of single condition queries.

40. A method according to any of claims 33-39, wherein receiving the one or more queries comprises receiving one or more queries that compile into a plurality of directives.

41. A method according to any of claims 33-40, comprising compiling the received one or more queries according to the selected method.
